(19) United States
(12) Patent Application Publication
(10) Pub. No.: US 2005/0105960 A1
(43) Pub. Date: May 19, 2005

(54) BINDER WITH SPINE STORAGE COMPARTMENT

(75) Inventor: Stephen D. Wehmeyer, Cincinnati, OH (US)

Correspondence Address: THOMPSON HINE L.L.P., 2000 COURTHOUSE PLAZA , N.E., 10 WEST SECOND STREET, DAYTON, OH, 45402, US

(73) Assignee: Mead Westvaco Corporation

(21) Appl. No.: 10/717,308

(22) Filed: Nov. 19, 2003

(51) Int. Cl. B42F 13/00

(52) U.S. Cl. 402/73

(57) ABSTRACT

A binder including a spine, a pair of covers pivotally coupled to opposite edges of the spine, and a storage component located on an outer surface of the spine. The storage component defines a storage cavity therein for receiving loose articles and includes an access door that is pivotable about an axis that extends generally parallel to the spine to provide access to the storage cavity.

### BACKGROUND

Binders and other similar components may be used to store loose-leaf papers, bound notebooks, etc. Users of such binders may typically also utilize writing instruments and other accessories for use with the binder. However, existing binders may lack sufficient storage space for storing such writing instruments, accessories and other loose components. Accordingly, there is a need for a binder which can store writing instruments, accessories and other loose components.

### SUMMARY

In one embodiment, the present invention is a binder which includes a storage component located on an outer surface of the spine such that writing instruments and other loose components can be stored therein. In particular, in one embodiment of the invention is a binder including a spine, a pair of covers pivotally coupled to opposite edges of the spine, and a storage component located on an outer surface of the spine. The storage component defines a storage cavity therein for receiving loose articles and includes an access door that is pivotable about an axis that extends generally parallel to the spine to provide access to the storage cavity. Other objects and advantages of the present invention will be apparent from the following description and the accompanying drawings.

### BRIEF DESCRIPTION OF THE DRAWINGS

FIG. 1 is a rear perspective view of one embodiment of the binder of the present invention, with the binder shown in its closed position and the access door in its closed position;

FIG. 2 is a front perspective view of the binder of FIG. 1, shown in its open position;

FIG. 3 is a rear perspective view of the binder of FIG. 2, with the access door in its open position; and

FIG. 4 is a rear perspective view of the binder of FIG. 1, with the label door in an exploded position.

### DETAILED DESCRIPTION

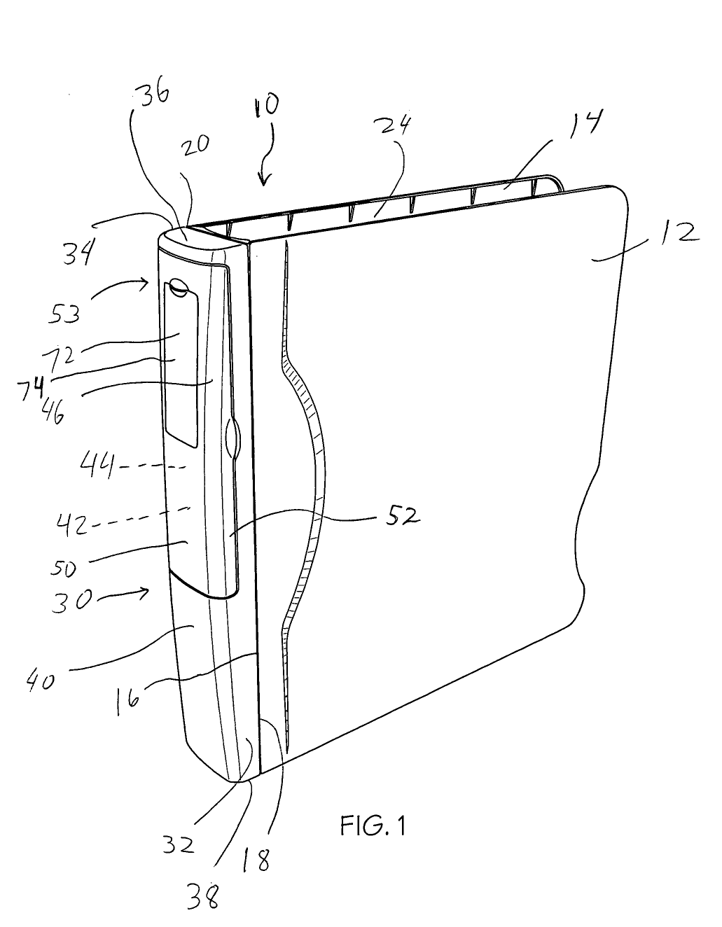

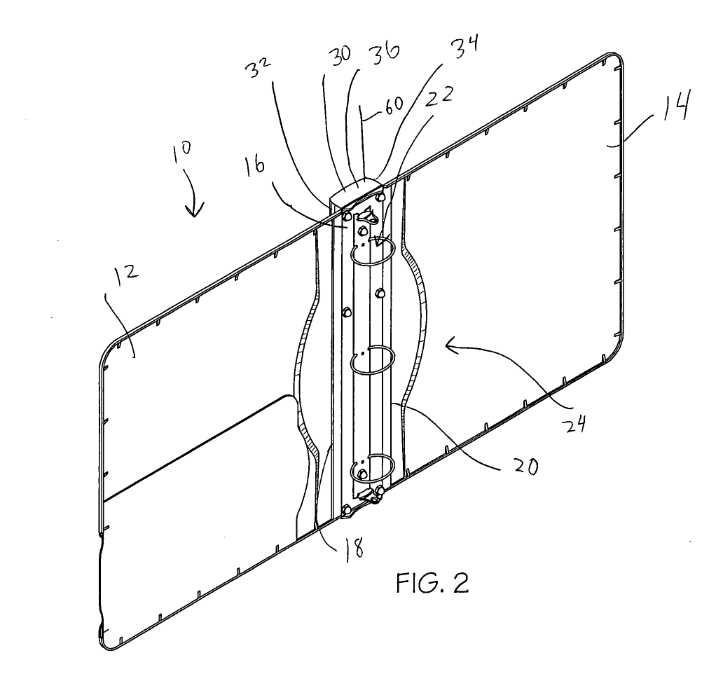

As shown in FIGS. 1-3, in one embodiment the binder of the present invention, generally designated 10, may include a front cover 12, a rear cover 14 and a spine 16. Each of the front cover 12, rear cover 14 and spine 16 may be generally flat and planar and generally rectangular in front view. Furthermore, each of the front cover 12, rear cover 14 and spine 16 may be made of relatively stiff and/or rigid material (i.e., sufficiently rigid to support a stack of school components (such as several pounds)) located thereon without significant deformation. The spine 16 may include a pair of opposed outer edges 18, 20 and each of the covers 12, 14 may be pivotally coupled to ones of the edges 18, 20, respectively. The binder 10 may include a binding mechanism 22 (FIG. 2) such as a three-ring binding mechanism, located on an inner surface 24 of the binder 10 such as on an inner surface of the spine.

The binder may include a storage component or compartment, generally designated 30, located on or integrated into an outer surface of the spine 18. The storage compartment 30 may include a pair of side walls 32, 34 oriented generally perpendicular to the spine 16. When the binder 10 is in its closed position (i.e., the covers 12, 14 are generally parallel and facing each other), each side wall 32, 34 may each extend generally parallel to, and be generally co-planar with, an associated one of the covers 12, 14. The storage compartment 30 may extend generally the entire height (i.e., length) of the spine 16, and may have the same surface area in front view such that the spine 16 is generally entirely “covered” by the storage compartment 30. The storage compartment 30 may be generally fixedly and nonremovably coupled to the spine 16 by, for example, rivets, fasteners, adhesives, stakes, etc. or be integrally molded with the spine 16.

The storage compartment 30 may further include a pair of end walls 36, 38, each end wall 36, 38 being oriented generally perpendicular to the spine 16 and to the side walls 32, 34. The storage compartment 30 may further include a backing wall 40 which is oriented generally perpendicular to the side walls 32, 34 and the end walls 36, 38, and generally parallel to and spaced apart from the spine 16. The remaining sixth wall of the storage compartment 30 may be formed by the outer surface of the spine 16, or by some other wall or component mounted to the spine 16. In this manner, at least part of the storage compartment 30 and/or storage cavity 42 inside of the storage compartment 30 may be defined by an outer surface of the spine 16 and may have a storage compartment 42 that extends generally the entire height of the spine 16.

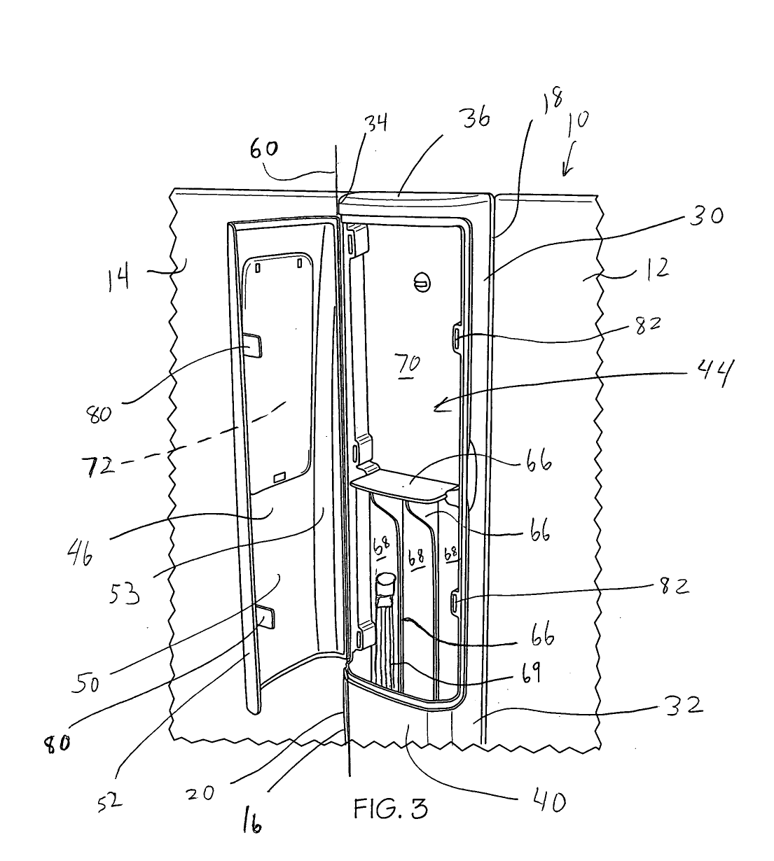

The storage compartment 30 may include the storage cavity 42 located therein and defined by the end walls 36, 38, side walls 32, 34, backing wall 40 and spine 16. The storage compartment 30 may include an access opening 44 located at an upper end of the storage compartment 30 to provide access to the storage cavity 42. The storage component 30 may include a cover or an access door 46 that can selectively cover the access opening 44. For example, the access door 46 may be pivotable between a closed position wherein the access door 46 generally covers the access opening 44 (FIG. 1), and an open position wherein the access door 46 is at least partially spaced apart from and/or generally does not cover the access opening 44 (FIG. 3).

In the illustrated embodiment, the access opening 44 is formed in the backing wall 40 as well as portions of the side walls 32, 34. Accordingly, the access door 46 may include a main, generally flat component 50 shaped to align with the backing wall 40 when the access door 46 is in its closed position, as well as a pair of flanges 52, 53 extending generally perpendicular to the backing wall 50 and shaped to align with the side walls 32, 34 when the door 46 is in its closed position.

The access door 46 may be coupled to the side wall 34 at or adjacent to the end flange at 53 to define a pivot axis 60 (FIG. 3). The pivot axis 60 may extend generally vertically or generally parallel to the spine 16. Furthermore, the pivot axis 60 may be spaced away from the spine 16 of the binder 10 in a direction generally perpendicular to the plane of the spine 16. In the illustrated embodiment, the pivot axis 60 is located closer to the backing wall 40 than to the spine 16. Furthermore, various configurations of the access opening 44 and access door 46 may be utilized. For example, the access opening 44 may be formed only in the backing wall 40, in which case the access door 46 may be generally flat and planar, and may be pivotally coupled to the backing wall 40.

If desired, the storage component 30, or portions of the storage component 30, may be generally translucent or transparent so that components stored in the storage compartment 30 can be easily viewed from outside the storage component. Furthermore, the storage component 30 may include various dividers 66 located therein to divide the storage cavity 42 into subcompartments. For example, subcompartments 68 may be shaped to receive writing instruments 69 therein and subcompartment 70 may be configured to receive other loose items, such as, for example, loose change, paper clips, erasers, electronic components, etc.

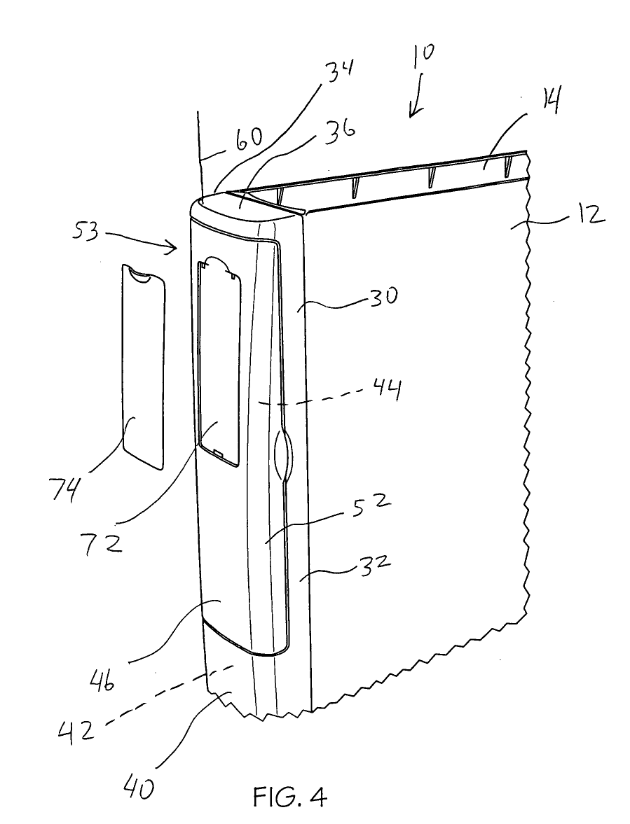

The storage compartment 30 may include a label opening 72 formed therein. In particular, the access door 46 may include a label door 74 which can be separated from the storage compartment (FIG. 4) such that a label can be inserted into the label opening 72. The label door 74 may then be returned to its closed position to trap the label in the label opening 72. The label door 74 may be made of a generally transparent material so that a label stored in the label opening 72 may be visible to a user. The label door 74 may also be pivotally coupled to the storage compartment.

As shown in FIG. 3, the access door 46 may include a pair of generally inwardly-extending flanges 80, and each flange 80 may be shaped and arranged to be received in a slot 82 located at or adjacent to sidewall 32 of compartment 30. In this manner, when each flange 80 is received in a slot 82 (i.e., when the door 46 is in its closed position), the flanges 80 and slots 82 may cooperate to maintain the door 46 in its closed position. The flanges 80 may be able to be pulled out of the slots 82 when sufficient force is applied (i.e., manually by a user) to open the door 46. Of course, a wide variety of other mechanisms and means for retaining the access door 46 in its closed position may be used without departing from the scope of the present invention.

In this manner, the storage compartment 30 provides an inner cavity 42 in which loose items can be easily stored by a user. In particular, because the storage compartment 30 is located on an outer surface of the binder 10, the storage compartment 30 can be easily accessed without having to open the binder 10. Furthermore, because the storage compartment 30 is located on the spine 16 of the binder 10, when the binder 10 is located in a “stack” of other items (that is, the binder is stuffed into a locker, backpack or the like with only its spine visible or accessible), a user can access the components stored in the spine storage component 30 without having to remove the binder 10 and/or access the inner surface of the binder 10. Furthermore, if the spine storage compartment 30 is made of generally transparent materials, the contents of the storage component 30 can be easily identified.

Having described the invention in detail and by reference to the preferred embodiments, it will be apparent that modifications and variations thereof are possible without departing from the scope of the invention.

1. A binder comprising:
a spine having a length extending in a longitudinal direction;
a pair of covers pivotally coupled to opposite edges of said spine;
a storage component located on an outer surface of the spine, said storage component defining a storage cavity therein for receiving loose articles; and
an access door pivotally coupled to said storage compartment about an axis that extends generally parallel to said spine to provide access to said storage cavity, said access door having a length extending in said longitudinal direction that is less than said length of said spine.

2. The binder of claim 1 wherein said axis is spaced away from said spine.

3. The binder of claim 1 wherein said storage component includes a pair of side walls oriented generally perpendicular to said spine and generally parallel to each other, the side walls being generally fixedly and nonremovably coupled to said spine.

4. The binder of claim 3 wherein said storage component further includes a pair of end walls oriented generally perpendicular to said spine and to said side walls.

5. The binder of claim 4 wherein said storage component further includes a backing wall oriented generally perpendicular to said side walls and to said end wall and generally parallel to said spine, wherein said storage component includes an access opening which is located in said backing wall.

6. The binder of claim 5 wherein said door is movable between a closed position wherein said door generally covers said access opening and an open position wherein said door generally does not cover said access opening.

7. The binder of claim 1 wherein said storage component extends generally the entire length of said spine.

8. The binder of claim 1 wherein said storage component includes internal dividers dividing said storage component into a series of sub-compartments.

9. The binder of claim 1 wherein said storage component is generally made of generally transparent material such that any contents of said storage component are visible from outside said storage component.

10. The binder of claim 1 further including a binding mechanism located on an inner surface of said binder.

11. The binder of claim 1 wherein said storage component is at least partially defined by said outer surface of said spine.

12. The binder of claim 1 wherein said spine and said covers are generally flat, planar components and are generally rectangular in front view.

13. The binder of claim 1 wherein said storage component includes a backing wall extending generally parallel to and spaced apart from said spine and wherein said pivot axis is located closer to said backing wall than to said spine.

14. The binder of claim 1 wherein said storage component is fixedly and non-removably coupled to said spine.

15. The binder of claim 1 wherein said axis is spaced away from said spine in a direction perpendicular to said spine.

16. (canceled)

17. The binder of claim 1 wherein said storage component includes a pair of side walls oriented generally perpendicular to said spine and generally parallel to each other, the side walls being generally fixedly and nonremovably coupled to said spine, a pair of end walls oriented generally perpendicular to said spine and to said side walls, and a backing wall oriented generally perpendicular to said side walls and to said end wall and generally parallel to said spine, wherein said backing wall includes an access opening, and wherein said door is movable between a closed position wherein said door generally covers said access opening and an open position wherein said door generally does not cover said access opening.

18. The binder of claim 1 wherein said storage component includes a wall generally spaced away from said spine such that said storage cavity is generally located between said wall and said spine, and wherein said wall includes an access opening, and wherein said door is movable between a closed position wherein said door generally covers said access opening and an open position wherein said door generally does not cover said access opening.

19. The binder of claim 1 wherein said binder includes an binding mechanism located on an inner surface thereof, and wherein said binder is movable to a closed position wherein said front and rear covers are generally parallel and facing each other with said binding mechanism located therebetween, and wherein said outer surface is on an opposite side of said spine relative to said inner surface.

20. A binder composing:
a generally flat, planar spine;
a pair of covers pivotally coupled to opposite edges of said spine;
a storage component located on an outer surface of said spine, said storage component defining a storage cavity therein for receiving loose articles, said storage component including a backing wall extending generally parallel to and spaced away from said spine in a lateral direction such that said storage cavity is generally located between said backing wall and said spine, and wherein said backing wall includes an access opening; and
a door pivotally coupled to said storage compartment and being pivotable about a pivot axis between a closed position wherein said door generally covers said access opening and an open position wherein said door generally does not cover said access opening, and wherein said pivot axis is spaced apart from said spine and from said backing wall in said lateral direction.

21. The binder of claim 20 wherein said door is pivotable about an axis that extends generally parallel to said spine.

22. A binder comprising:
a generally flat, planar spine;
a pair of covers pivotally coupled to opposite edges of said spine; and
a storage component located on an outer surface of said spine, said storage component defining a storage cavity therein for receiving loose articles, said storage component including a pair of side walls oriented generally perpendicular to said spine, a pair of end walls oriented generally perpendicular to said spine and to said side walls, and a backing wall oriented generally parallel to said spine, said storage component including an access opening located in at least one of said side walls, said end walls or said backing wall to provide access to said storage cavity, said storage component further including an access door that is pivotally coupled to at least one or said side walls, said end walls or said backing wall and is pivotable about an axis extending generally parallel to said spine to selectively cover said access opening, said axis being spaced apart from said spine, wherein said backing wall extends generally parallel to and is spaced apart from said spine in a lateral direction, and wherein said pivot axis is spaced apart from said spine and from said backing wall in said lateral direction.

23. A binder comprising:
a spine having a length;
a pair of covers pivotally coupled to opposite edges of said spine; and
a storage component fixedly coupled to an outer surface of the spine, said storage component defining a storage cavity therein for receiving loose articles, said storage component including an access door that is pivotable about an axis that extends generally parallel to said spine to provide access to said storage cavity, said access door having a length less than said length of said spine.

24. The binder of claim 1 wherein said storage compartment includes a backing wall extending generally parallel to and spaced apart from said spine in a lateral direction, and wherein said pivot axis is spaced apart from said spine and from said backing wall in said lateral direction.

25. The binder of claim 1 wherein said spine is a generally flat, planar component.

26. The binder of claim 1 wherein said door has a length of no more than about 62.5% than the length of said spine.

27. (canceled)

28. The binder of claim 20 wherein said spine is a generally flat, planar component.

29. The binder of claim 20 wherein said storage compartment extends generally the entire length of said spine.

30. The binder of claim 20 wherein said door has a length of no more than about 62.5% than the length of said spine.

31. The binder of claim 20 wherein said spine has a length extending in a longitudinal direction and wherein the access door has a length extending in the longitudinal direction that is less than the length of the spine.

32. (canceled)

33. The binder of claim 22 wherein said spine has a length extending in a longitudinal direction and wherein the access door has a length extending in the longitudinal direction that is less than the length of the spine.

34. The binder of claim 33 wherein said door has a length of no more than about 62.5% than the length of said spine.

35. The binder of claim 23 wherein said storage compartment includes a backing wall extending generally parallel to and spaced apart from said spine in a lateral direction, and wherein said pivot axis is spaced apart from said spine and from said backing wall in said lateral direction.

36. The binder of claim 23 wherein said spine is a generally flat, planar component.

37. The binder of claim 23 wherein said axis is spaced away from said spine.

38. The binder of claim 23 wherein said door has a length of no more than about 62.5% than the length of said spine.
